(19) United States
(12) Patent Application Publication
(10) Pub. No.: US 2001/0034752 A1
(43) Pub. Date: Oct. 25, 2001

(54) Method and system for symmetrically distributed adaptive matching of partners of mutual interest in a computer network

(75) Inventor: Orly Kremien, Rahmat Hasharon (IL)

Correspondence Address: FITCH EVEN TABIN AND FLANNERY, 120 SOUTH LA SALLE STREET, SUITE 1600, CHICAGO, IL, 606033406

(73) Assignee: PROMPT2U INC.

(21) Appl. No.: 09/769,785

(22) Filed: Jan. 25, 2001

Related U.S. Application Data
(63) Continuation-in-part of application No. 09/491,833, filed on Jan. 26, 2000.

(51) Int. Cl. G06F 9/00; G06F 17/30

(52) U.S. Cl. 709/105; 707/6

(57) ABSTRACT

An adaptive, symmetrically distributed load balancing system and method for resource management in a computer network. The architecture is fully symmetrical, with all nodes executing the same system code and treated as equivalent. The system is therefore inherently fault-tolerant and scalable to any degree, with a load balancing capacity that increases linearly with cluster size. An extension from single cluster operation to multi-site operation is provided, and performance is optimized through locality enhancement, by tracking latencies to select nodes offering the fastest response. Both inter-cluster and intra-cluster latency information is maintained. The system also selectively retains past states and thus has access to a rich set of recent past extents (represented in a cache) which may still be valid, and which serve as hints of good quality. Session support by all cluster members as well as support for quality of service are also provided.

### FIELD OF THE INVENTION

The present invention relates to computer network resource allocation in general, and to network load balancing in particular.

### BACKGROUND OF THE INVENTION

Computer networks include certain computers designated to act as “servers”, or providers of data on request to other computers on the network, often referred to as “clients”. Early servers consisted of a single computer of high capacity. With the rapid growth of networks such as the Internet, a single computer is usually inadequate to handle the load. To overcome the limitation of single-computer servers, “clusters” of interconnected computing facilities may be used. FIG. 1 conceptually illustrates a prior-art cluster 100, utilizing computing facilities 105, 110, 115, 120, 125, 130, and 135, which are interconnected by intra-cluster communication lines, such as an intra-cluster communication line 140, and which may be connected to external computing facilities or clusters outside cluster 100 via one or more inter-cluster communication lines such as an inter-cluster communication line 145. Here, the term “computing facility” denotes any device or system which provides computing capabilities. Because a “cluster” is commonly defined as a collection of interconnected computing devices working together as a single system, the term “computing facilities” can therefore refer not only to single computers but also to clusters of computers.

FIG. 2 illustrates how cluster 100 can be realized utilizing computing facilities which are themselves clusters. In FIG. 2, computing facility 105 is a cluster 205, computing facility 110 is a cluster 210, computing facility 115 is a cluster 215, computing facility 120 is a cluster 220, computing facility 125 is a cluster 225, computing facility 130 is a cluster 230, and computing facility 135 is a cluster 235. In FIG. 2, communication line 140, which is an intra-cluster communication line with regard to cluster 100, can be considered as an inter-cluster communication line between cluster 225 and cluster 235. The configuration of FIG. 2 is also referred to as a “multi-site” configuration, whereas the configuration of FIG. 1 is referred to as a “single-site” configuration. The different computing facilities within a network are also referred to as “nodes”. In all cases, when considering the contributions of the different computing facilities within a cluster to the overall integrated operation of the cluster, the individual computing facilities are herein denoted as “cluster members”. For example, computing facility 135 is a cluster member of cluster 100, and a computing facility 240 is a cluster member of cluster 235, which makes up computing facility 135 (FIG. 2). FIG. 1 and FIG. 2 illustrate how the clustering concept is scalable to any desired practical size and level. In a large network, such as the Internet, it is possible to construct high-level clusters which extend geographically over great distances and involve large numbers of individual computers. The term “size” herein denotes the number of computing facilities within a cluster, and is reflected in the overall available computing power of the cluster. On the other hand, the term “level” herein denotes the degree of the cluster composition in terms of individual servers. For example, a single-site cluster, whose cluster members (the computing facilities) are individual servers would be considered a first-level cluster. A multi-site cluster, whose cluster members are, say, first-level clusters would be considered a second-level cluster, and so forth. The term “sub-cluster” herein denotes any cluster which serves as a computing facility within a higher-level cluster. Multi-site clusters can also be of an even higher-level than second-level clusters. A high-level cluster typically would also have a large size, because the sub-clusters that make up the computing facilities of a high-level cluster themselves contain many smaller computing facilities.

A cluster provides computing power of increased capacity and bypasses the constraints imposed by a single computer. Although a cluster can have considerably greater computing power than a single computer, it is necessary to distribute the work load efficiently among the cluster members. If effective work load distribution is not done, the full computing capacity of the cluster will not be realized. In such a case, some computing facilities in the cluster will be under-utilized, whereas other computing facilities will be overburdened. Methods of allocating the work load evenly among the cluster member of a cluster are denoted by the term “load balancing”, and a computing facility which performs or directs load balancing is herein denoted as a “load balancer”. Load balancing is a non-limiting case of “resource allocation”, in which involves matching a “service provider” with a “service requester”. In the general case, a service requester may be assigned to a first service provider which is unable to provide the requested service for one reason or another. There may, however, be a second service provider which is capable of providing the requested service to the service requester. It is desired, therefore, to match such service providers together in order to fulfill the request for service The term “mutual interest” herein denotes a relationship between such a pair of service providers, one of which is unable to handle a request for service, and the other of which has the ability to do so

The problem of resource allocation is a general one involving the availability of supply in response to demand, and is experienced in a broad variety of different areas. For example, the allocation of parking spaces for cars is a special case of this problem, where a parking facility with a shortage of space has a mutual interest with a nearby facility that has a surplus of space. Electronic networks are increasingly involved in areas that must confront the problem of resource allocation. The present invention applies to resource allocation over electronic networks in general, and is illustrated in the non-limiting special case of load balancing. Other areas where resource allocation over electronic networks is of great importance, and where matching mutual interest is valuable and useful include, but are not limited to, electronic commerce and cellular communications. In a cellular infrastructure, for example, cells in proximity with one another could have a mutual interest in responding to user demand for service. In electronic commerce, as another non-limiting example, companies selling similar products over a network could have a mutual interest in responding rapidly to fluctuating customer demand. In general, the term “electronic commerce” herein denotes any business or trade conducted over an electronic network, and the present invention is applicable to mutual-interest matching in this area.

Many cluster-based network servers employ a cycled sequential work load allocation known in the art as a “round robin” allocation. As illustrated in FIG. 3, a cluster 300 employs a load balancer 305 which sequentially assigns tasks to cluster members 310, 315, 320, 325, 330, and 335 in a preassigned order. When the sequence is complete, load balancer 305 repeats the sequence over and over. This scheme is simple and easy to implement, but has the serious drawback that the load balancer ignores the operational status of the different cluster members as well as the variations in work load among different cluster members. The operational status of a computing facility, such as faults or incapacities, or the absence thereof is generally denoted in the art as the “health” of the computing facility. Ignoring factors such as health and work load variations has a significant negative impact on the effectiveness of the load balancing. In addition to round robin allocation, there are schemes in the prior art which rely on random allocation. These schemes also suffer from the same drawbacks as round robin allocation.

An “adaptive load balancer” is a load balancer which is able to change load balancing strategy in response to changing conditions. As illustrated in FIG. 4, a cluster 400 employs an adaptive load balancer 405 which assigns task to cluster members 410, 415, 420, 425, 430, and 435. Unlike the simple round robin scheme of FIG. 3, however, adaptive load balancer 405 is informed by cluster members of health, work load variations, and other performance conditions. This is done by an “agent” within each cluster member, illustrated as an agent 412 in cluster member 410, an agent 417 in cluster member 415, an agent 422 in cluster member 420, an agent 427 in cluster member 425, an agent 432 in cluster member 430, and an agent 437 in cluster member 435. Information supplied to the adaptive load balancer by the agents enables load balancing to take health and other performance-related factors into account when assigning the work load among the various cluster members. Although this represents a major improvement over the simple round robin scheme, there are still limitations because there is a single load balancer that assigns the work load among many other computing facilities. Such an architecture is herein denoted as an “asymmetric architecture”, and is constrained by the capacity of the single load balancer. In contrast, a load balancing architecture where the function of the load balancer is distributed evenly among all the cluster members implements a distributed load balancing, and is herein denoted as a “symmetric architecture”. A symmetric architecture is superior to asymmetric architecture because the bottleneck of the single load balancer is eliminated. Currently, however, all Internet Traffic Management solutions are either centralized or employ an asymmetric architecture, and therefore suffer from the limitations of a single load balancer. For example, U.S. Pat. No. 5,774,660 to Brendel, et al. (“Brendel”), discloses an Internet server for resource-based load balancing on a distributed resource multi-node network. The Brendel server, however, employs a single load balancer. Although a hot backup is provided in case of failure, this is nevertheless an asymmetric architecture, and suffers from the limitations thereof.

As discussed above, round robin load balancing is unsatisfactory chiefly because of the inability to handle failures of cluster members. Even with an adaptive load balancer, with all agent on each cluster member, there is still the limitation that the whole cluster is managed by a single centralized load balancer. Where the cluster size is relatively small, such solutions may be satisfactory. The work load on the Internet, however, is growing exponentially at a rapid pace. In order to handle this much higher work load, the cluster size will have to be increased substantially, and clusters of large size cannot be efficiently managed by a centralized load balancer.

In order to enable their decision making, centralized load balancing solutions must maintain state information regarding all cluster members in one location. Such centralized load balancers are therefore not scalable, the way the clusters themselves are scalable, as illustrated in FIG. 1 and FIG. 2. A “scalable” load balancing architecture is one whose capacity increases with cluster size, and therefore is not constrained by a fixed capacity. In system with a centralized load balancer, however, the overhead involved in cluster management will eventually grow to the point of overwhelming the capacity of the non-scalable centralized load balancer. For this reason, centralized load balancing solutions are not satisfactory. Scalability is necessary for Internet Traffic Management (ITM).

### Distributed Load Balancing

To be scalable, a method of load balancing must distribute the load balancer over the entire cluster. Doing so will insure that as the cluster grows, so does the load balancing capacity. In addition to achieving scalability, this also has the additional benefit of assuring that there is no single point of failure. For scalability, the demand for any resource should be bounded by a constant independent of the number of cluster members in a cluster. Note that in distributed load balancing, each cluster member has an agent responsible for disseminating health and other performance-related information throughout the entire cluster, not simply to a single fixed load balancer, as illustrated in FIG. 4.

To achieve scalability, a computing facility performing distributed load balancing should use only partial information of a constrained size. Although not currently implemented for Internet Traffic Management, there are load balancing algorithms known in the art for distributed systems based on the principle of multiple, identical load balancing managers (or symmetrically-distributed load balancing managers) using partial information. This was advocated in “Adaptive Load Sharing in Homogeneous Distributed Systems”, by Derek L. Eager, Edward D. Lazowska, and John Zahorjan, IEEE Transactions on Software Engineering, 12(5):662-675, May 1986. A general overview of the prior art of distributed load balancing is presented in High Performance Cluster Computing, Vol. 1 “Architectures and Systems”, edited by Rajkumar Buyya, 1999, ISBN 0-13-013784-7, Prentice-Hall, in particular, Chapter 3 “Constructing Scalable Services”, by the present inventor et al., pages 68-93.

In a distributed mutual-interest matching architecture, illustrated here in the non-limiting case of a distributed load balancing architecture, no single cluster member ever holds global information about the whole cluster state. Rather, single cluster members have non-local information about a subset of the cluster, where the subset has a constrained size. This small subset constitutes the cluster member's environment for purposes of matching mutual interests, such as for load balancing. In the case of FLS, the cluster member exchanges information only with other cluster members of the subset. Limiting the message exchange of each cluster member results in that cluster member's exchanging information only with a small, bounded subset of the entire cluster. FLS is thus superior to other prior-art schemes which do not limit themselves to a bounded subset of the cluster, and thereby are liable to be burdened with excessive information traffic.

Another principle which is significant as clusters grow in size is locality. Locality is a measure of the ability of a cluster member to respond to requests swiftly based on information available locally regarding other cluster members. A good scalable mutual-interest matching method (such as for load balancing) must be able to efficiently match mutual interests, based on non-local, partial and possibly outdated or otherwise inaccurate information.

State inflation available to a cluster member can never be completely accurate, because there is a non-negligible delay in message transfer and the amount of information exchanged is limited. The algorithm employed should have a mechanism for recovery from bad choices made on outdated information. The non-local information may be treated as “hints”. Hints should be accurate (of high “quality”), but must be validated before being used. Also, in order to account for scalability, the algorithm design should be minimally dependent on system size as well as physical characteristics such as communication bandwidth and processor speed.

Currently, the most advanced prior-art distributed load balancing is that of the “Flexible Load Sharing” system (hereinafter denoted as “FLS”), as described below and in “Scalable and Adaptive Load Sharing Algorithms”, by the present inventor et al., IEEE Parallel and Distributed Technology, pages 62-70, August 1993, which is incorporated by reference for all purposes as if fully set forth herein.

Cluster resource sharing aims at achieving maximal system performance by utilizing the available cluster resources efficiently. The goal of a load balancing algorithm is to efficiently match cluster members with insufficient processing resources to those with an excess of available processing resources. A mutual interest (as previously defined in the general case) thus pairs a node having a deficit of processing resources with a node having a surplus of processing resources. A load balancing algorithm should determine when to be activated, i.e. when a specific cluster member of the cluster is in the state eligible for load balancing. FLS periodically evaluates processor utilization at a cluster member, and derives a load estimate L for that cluster member, according to which that cluster member may be categorized as being underloaded, overloaded, or at medium load.

FLS uses a location policy (for server location) which does not try to find the best solution but rather a sufficient one. For scalability, FLS divides a cluster into small subsets (herein denoted by the term “extents”), which may overlap. As illustrated in FIG. 5, a cluster 500 is divided into such extents, two of which are shown as an extent 505 containing nodes 520, 525, 530, 540, 545, 560, 565, and 570, and a extent 510 containing nodes 515, 520, 525, 535, 540, 550, 555, and 560. Note that in this example, extents 505 and 510 overlap, in that both contain nodes 520, 525, 540, and 560. Each extent is also represented in a “cache” held at a node. As illustrated in FIG. 6, extent 505 is represented in a cache 600 within node 545. Cache 600 can contain data images 620, 625, 630, 640, 645, 660, 665, and 670, which represent nodes 520, 525, 530, 540, 545, 560, 565, and 570, respectively. The purpose of cache 600 is to contain data representing nodes of mutual interest within extent 505. If, for example, node 545 were underloaded (as represented by data image 645), then nodes 525, 540, 565, and 570 (represented by data images 625, 640, 665, and 670) would have a mutual interest, and would remain as active in the cache. The nodes of mutual interest are first located by pure random sampling. Biased random selection is used thereafter to retain entries of mutual interest and select others to replace discarded entries. The FLS algorithm supports mutual inclusion and exclusion, and is further rendered fail-safe by treating cached data as hints. In order to minimize state transfer activity, the choice is biased and nodes sharing mutual interest are retained. In this way premature deletion is avoided. In a manner similar to that illustrated in FIG. 6, node 535 (FIG. 5) has a cache representing the states of the nodes of extent 510. Although the cache of node 535 represents some nodes in common with that of the cache of node 545, the mutual interests of the cache of node 535, however, are not necessarily the same as those of the cache of node 545 for the common nodes.

As an method of distributed load balancing FLS addresses a system of N computers which is decomposed into overlapping extents of size M, such that M is significantly smaller than N (M<<N). Extent members are nodes of mutual interest (overloaded/underloaded pairs). The extent changes slowly during FLS operation as described below. The extent (represented within the cache) defines a subset of system nodes, within which each node seeks a complementary partner. In this manner, the search scope is constrained, no matter how large the cluster as a whole becomes. Each load balancing manager informs the M extent members of health and load conditions whenever there is a significant change. As a result, no cluster member is vulnerable to being a single point of failure or a single point of congestion. N managers (cluster members) coordinate their actions in parallel to balance the load of the cluster. FLS exhibits very high “hit ratio”, a term denoting the relative number of requests for remote access that are concluded successfully.

In FLS the necessary information for matching nodes sharing a mutual interest is maintained and updated on a regular basis. This is in preference to waiting for the need to perform the matching to actually arise in order to start gathering the relevant information. This policy shortens the time period that passes between issuing the request for matching and actually finding a partner having a mutual interest. This low background activity of state propagation is one of the strengths of FLS, and is of major significance in an Internet environment, as will be described.

Load balancing is thus concerned with matching “underloaded” nodes with “overloaded” nodes. An overloaded node shares a mutual interest with an underloaded node. For any given overloaded node, matching is effected by locating an underloaded node, and vice-versa. In the absence of a central controls however, the mechanism for this locating is non-trivial.

FLS follows the principles stated previously, and has multiple load balancing managers with identical roles. Each of these load balancing managers handles a small subset (of size M) of the whole cluster locally in a cache. This subset of M nodes forms the node's environment. A node is selected from this set for remote execution. The M nodes of the extent are the only ones informed of the node's state. Because of this condition, message exchange is reduced and communication congestion is avoided. This information about the nodes is treated as a hint for decision-making, directing the load balancing algorithm to take steps that are likely to be beneficial. The load balancing algorithm is able to avoid and recover from bad choices by validating hints before actually using them, and rejecting hints that are not of high quality, as determined by the hit ratio. Because FLS is a symmetrically distributed algorithm, all nodes have identical roles and execute the same code. There is no cluster member with a fixed special role. Each cluster member independently and cooperatively acts as a site manager of M other cluster members forming an extent (represented within the cache). FLS is a scalable and adaptive load balancing algorithm for a single site which can flexibly grow in size. It is also to be emphasized that, in contrast with other prior-art load balancing mechanisms, FLS load balancers maintain information on only a subset of the entire cluster (the M nodes of a extent), rather than on every node of the cluster. This reduces network traffic requirements by localizing the communication of state information.

Unfortunately, however, FLS has several limitations. First, FLS is applicable only to the lowest-level clusters, whose computing facilities are individual computers (such as illustrated in FIG. 1), but not to higher-level clusters, whose computing facilities themselves may be clusters (such as illustrated in FIG. 2). In addition, FLS does not directly address latencies between two nodes within a cluster. The term “latency” denotes the time needed for one computing facility to communicate with another. FLS assumes that latencies are non-negligible but considers them roughly identical. FLS tries to minimize overall remote execution but does not address the individual values of the latencies themselves. In large networks, however, latencies can become significant as well as significantly different throughout a cluster. Failure to differentiate cluster members on the basis of latency can lead to non-optimal choices and degrade the load balancing performance. Because FLS is applicable only to a single-site configuration, FLS is also unable to consider inter-cluster latencies. Moreover, FLS lacks a number of enhancements which could further improve performance, such as uniform session support for all cluster members. These limitations restrict the potential value of FLS in a large network environment, such as the Internet.

There is thus a widely recognized need for, and it would be highly advantageous to have, a distributed load balancing system which is suitable for a multi-site configuration as well as a single-site configuration, and which explicitly takes latencies and session support into consideration. This goal is met by the present invention.

### SUMMARY OF THE INVENTION

According to the present invention, a distributed load balancing system and method are provided for resource management in a computer network, with the load balancing performed throughout a cluster utilizing a symmetric architecture, whereby all cluster members execute the same load balancing code in a manner similar to the previously-described FLS system. The present invention, however, provides several important extensions not found in FLS that offer performance optimization and expanded scope of applicability. These novel features include:

1. an extension to enable multi-site operation, allowing the individual computing facilities to be clusters of arbitrary level, rather than being limited to individual computers as in the prior art;

2. enhancement of locality by measuring and tracking inter-node latencies, and subsequent selection of nodes based on considerations of minimum latency;

3. selectively maintaining past node states for reuse of recent extent information (represented in a cache) as hints which may still be valid;

4. Session support by all cluster members; and

5. Quality of Service support.

Therefore, according to the present invention there is provided a system for distributed mutual-interest matching in a cluster of a plurality of nodes, wherein at least one node has a mutual interest with at least one other node, the system including: (a) at least one extent, each extent being a subset of the plurality of nodes; (b) at least one cache storage, each of the cache storages corresponding to one of the extents; and (c) a plurality of caches, at least one of the cache storages containing at least two caches from among the plurality of caches, wherein each cache is operative to containing data images of nodes having a mutual interest with a node, and wherein the data images in at least one cache selectively correspond to past mutual interests.

Moreover, according to the present invention there is provided a system for distributed mutual-interest matching in a cluster of a plurality of nodes, wherein at least one node has a mutual interest with at least one other node, and wherein at least one node includes a sub-cluster having a cluster state, the system including: (a) at least one monitor operative to informing nodes of the cluster state, wherein the at least one monitor is included within a sub-cluster; and (b) at least one designated gate operative to interacting with nodes of the cluster, wherein the at least one designated gate is included within a sub-cluster.

In addition, according to the present invention there is provided a method for distributed mutual-interest matching in a cluster containing a plurality of nodes, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches and wherein each cache is operative to containing data images of secondary nodes having a mutual interest with a primary node, the method including the steps of: (a) detecting a transition of a primary node; (b) performing an operation selected from the group including: saving a cache corresponding to a first node state in a cache storage and retrieving a cache corresponding to a second node state from a cache storage; and (c) utilizing the data images contained in a cache for locating a secondary node having a mutual interest with the primary node.

Furthermore, according to the present invention there is provided a method for distributed mutual-interest matching in a cluster containing a plurality of nodes, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches, wherein each cache is operative to containing data images of secondary nodes having a mutual interest with a primary node, and wherein each node within the plurality of nodes has a node address, the method including the steps of: (a) detecting a transition of a node, wherein the primary node establishes a session with a remote client and wherein the cluster makes a reply to the remote client; (b) performing an operation selected from the group including: saving a cache corresponding to a first node state in a cache storage and retrieving a cache corresponding to a second node state from a cache storage; (c) utilizing the data images contained in a cache for locating a secondary node having a mutual interest with the primary node; and (d) substituting the node address of the primary node for the node address of the secondary node in the reply to the remote client.

There is also provided, according to the present invention, a method for enhancing the locality of distributed mutual-interest matching in a cluster containing a plurality of nodes by measuring and tacking inter-node latencies, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches, wherein each cache is operative to containing data images of secondary nodes having a mutual interest with a primary node, and wherein the cluster receives requests from a plurality of remote clients, the method including the steps of: (a) detecting a transition of a primary node; (b) performing an operation selected from the group including: saving a cache corresponding to a first node state in a cache storage and retrieving a cache corresponding to a second node state from a cache storage; and (c) utilizing the data images contained in a cache for locating a secondary node having a mutual interest with the node, wherein the locating has an adjustable frequency; (d) providing a plurality of priority queues, each of the priority queues having a priority level; (e) tracking the number of requests for a priority queue; and (f) adjusting the adjustable frequency.

There is further provided a method for distributed mutual-interest matching in a cluster of a plurality of nodes, wherein at least one node has a mutual interest with at least one other node, and wherein at least one node includes a sub-cluster having a cluster state, the method comprising.

i) designating a monitor operative to informing nodes of the cluster state, and

ii) designating a ate operative to interacting with nodes of the cluster.

Still further, the invention provides a system for distributed mutual-interest matching in a cluster of a plurality of nodes, wherein at least one node includes a sub-cluster, the system comprising at least one seeking node from among the plurality of nodes, such that each one of said at least one seeking node being operative to locating a matching node among the plurality of nodes wherein said matching node has a mutual interest with said seeking node.

It should be noted that the seeking node is pre-defined/selected or dynamic, depending upon the particular application.

The invention further provides for use in the system of the kind specified a seeking node operative to locating a matching node among the plurality of nodes wherein said second node has a mutual interest with said seeking node.

### BRIEF DESCRIPTION OF THE DRAWINGS

The invention is herein described, by way of example only, with reference to the accompanying drawings, wherein:

FIG. 1 conceptually illustrates a prior-art cluster of computing facilities.

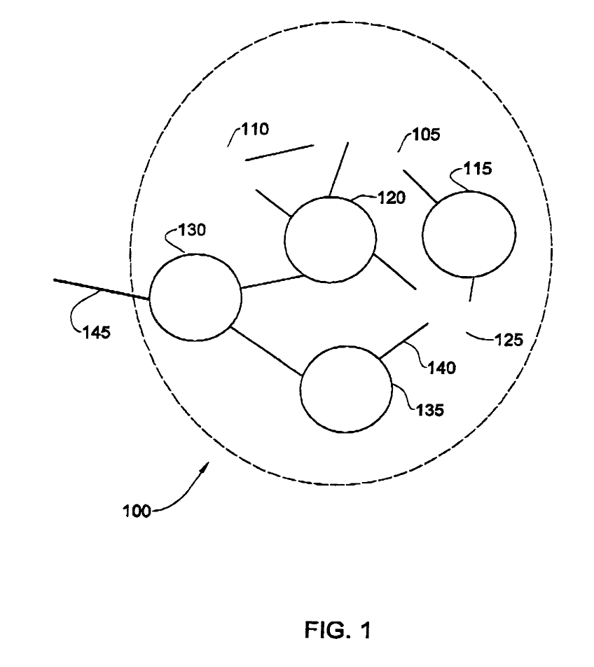

FIG. 2 conceptually illustrates a prior-art multi-cluster configuration.

FIG. 3 illustrates prior-art round robin load balancing.

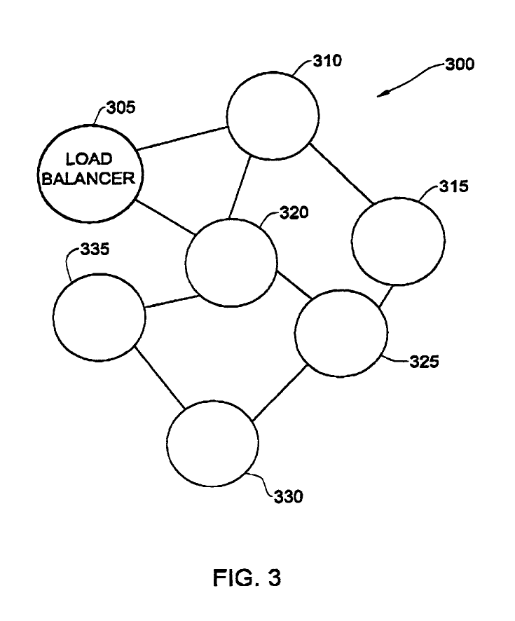

FIG. 4 illustrates a prior-art adaptive load balancer with agents.

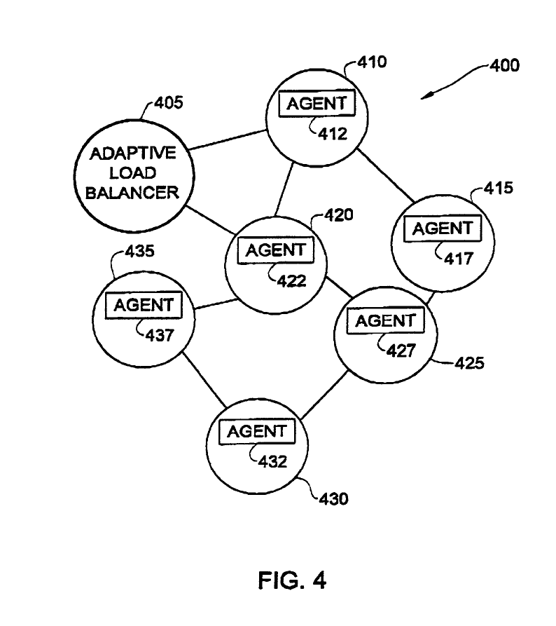

FIG. 5 schematically illustrates prior-art FLS distributed load balancing.

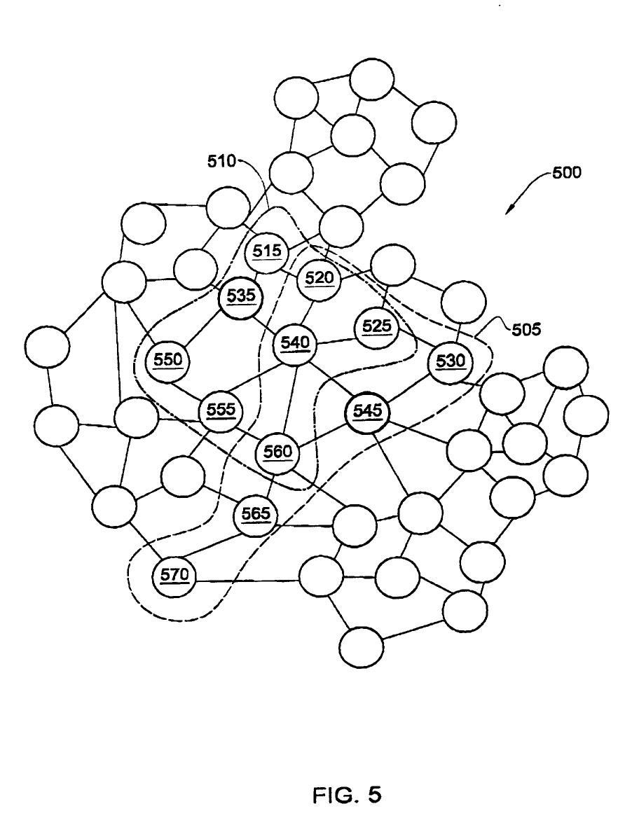

FIG. 6 illustrates a extent cache for distributed load balancing.

FIG. 7 conceptually illustrates the measurement of latency according to the present invention.

FIG. 8 conceptually illustrates multiple caching and the reuse of past state information according to the present invention.

FIG. 9 is a flowchart illustrating cache reuse according to the present invention.

FIG. 10 conceptually illustrates a cluster for use in a multiple-site configuration according to the present invention.

FIG. 11 is a flowchart illustrating the steps in determining the state of a cluster of a multi-site configuration and selecting a gate therefor, according to the present invention.

### DESCRIPTION OF THE PREFERRED EMBODIMENTS

The principles and operation of a distributed load balancing system and method according to the present invention may be understood with reference to the drawings and the accompanying description.

### Node States and Load Balancing Thresholds

Two load thresholds arc used: the overload threshold, T_{O}, and the underload threshold, T_{U}. A node state L is thus mapped into one of three possible states:

O—Overloaded, if L>T_{O},

U—Underloaded, if L<T_{U},

M—Medium load, if T_{U}≦L≦T_{O}

Each node maintains its local load state metric which is calculated periodically. Upon a local state transition (e.g. O to M transition), the local load balancer handling the load notifies the agent at the node, which is responsible for informing other node in its extent of this change.

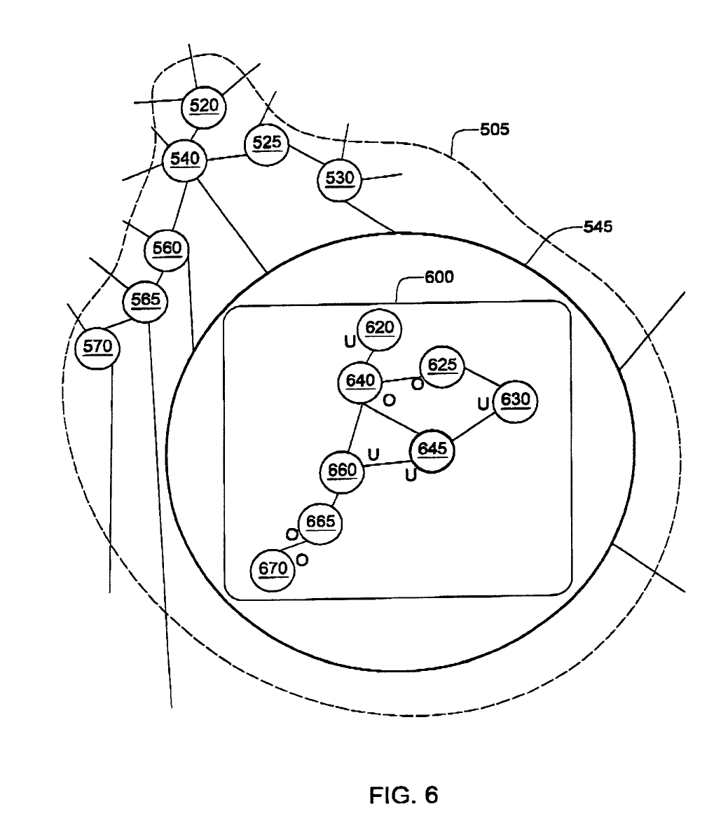

The load state metric is used to decompose the system into extents. A node exchanges state information with all nodes in its extent and selects from these for possible remote allocation of requests. The distributed load balancing is thus applied within each extent, independently of application in other extents. Extent membership is symmetrical: two node are members of each other's extent only if one node is underloaded and the other is overloaded. For example, in FIG. 6, it is seen that node 545 (represented in cache 600 by data image 645) and node 570 (represented in cache 600 by data image 670) have this symmetrical relationship. It is thus possible that node 545 can be within the extent represented by a cache within node 570.

It is also a key property for ensuring that a node is kept informed of the states of the nodes in its extent. A node retains useful nodes in its extent and discards nodes which are no longer of interest. This symmetry is a key property for Internet extensions like health and latency tracking. Extent membership is dynamic and adaptive, aimed at retaining those nodes of interest and discarding others. This may be formalized by defining a predicate candidateA,B, which evaluates to true, when node A and B are members of each other's caches, and false otherwise. The predicate candidateA,B is defined as follows:

candidateA,B≡(stateA=U AND stateB=O) OR (stateA=O AND stateB=U)≡NOT (stateA=M OR stateB=M OR stateA=stateB) (1)

Whenever the predicate candidateA,B holds, the nodes are mutually included (inserted), or otherwise excluded (discarded) from their respective cache lists. We can state this using an invariant: For all extents D( ), and nodes A and B, where A≠B, the following relationship holds

(B∈D(A) AND A∈D(B) AND candidateA,B)

OR

(B∈D(A) AND A∈D(B))

An important aspect of the present invention concerns matching underloaded nodes with overloaded nodes. An overloaded node shares a mutual interest with an underloaded node. In the absence of a central control, however, the mechanism for this matching is non-trivial. As previously noted, the best prior-art mechanism, FLS, has a limited ability to perform matching of underloaded and overloaded nodes.

### Enhanced Locality

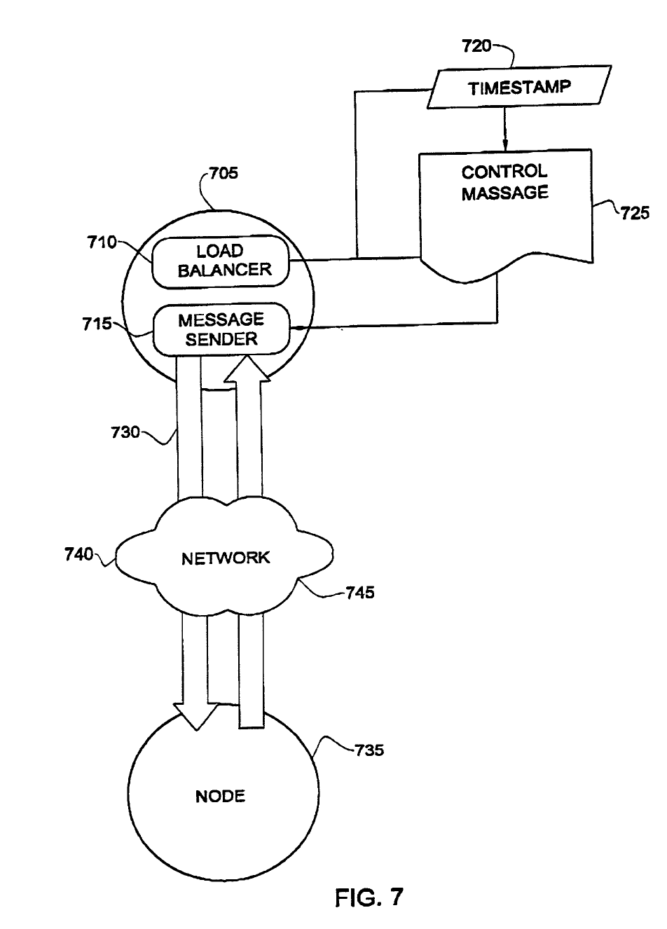

In a preferred embodiment of the present invention, estimating latencies increases the probability of finding an optimal partner for a node. Optimizing locality in a single-cluster or multiple-cluster environment improves performance. According to the present invention, the latencies between different pairs is dynamically tracked. As illustrated in FIG. 7, this is done by a load balancer 710 in a node 705. Load balancer 710 attaches a timestamp 720 to a control message 725, which is sent by a message sender 715 to a node 735 over a path 730 in a network 740. Control message 725 is sent back from node 735 over a path 745, which may be different from path 730. Upon the return of control message 725, the Round Trip Time (RTT) can be calculated by subtracting timestamp 720 from the arrival time. The most recent k RTT measurements are used to calculate the average latency. Extent members are ordered and selected according to decreasing latency. Because the transmissions take place over a network, the latencies are not constant, but in general will change over time.

### Multiple Caching for Recent State Reuse

An adaptive load balancer which assigns work to a node must be aware of the current state of that node. Typically, this is done by maintaining a cache holding current state information for all nodes which are managed by the adaptive load balancer. The adaptive load balancer, however, then has the task of regularly updating the cache (such as upon a change of state, or at periodic intervals) to insure that the information contained therein is current, and this continual updating adds to the work load of the load balancer itself. It is therefore desirable to reduce the necessity for updating the cache, and the present invention attains this goal by providing for multiple caching of state information and reuse of past caches. The multiple cache instances are held in a cache storage and retrieved therefrom, as described below.

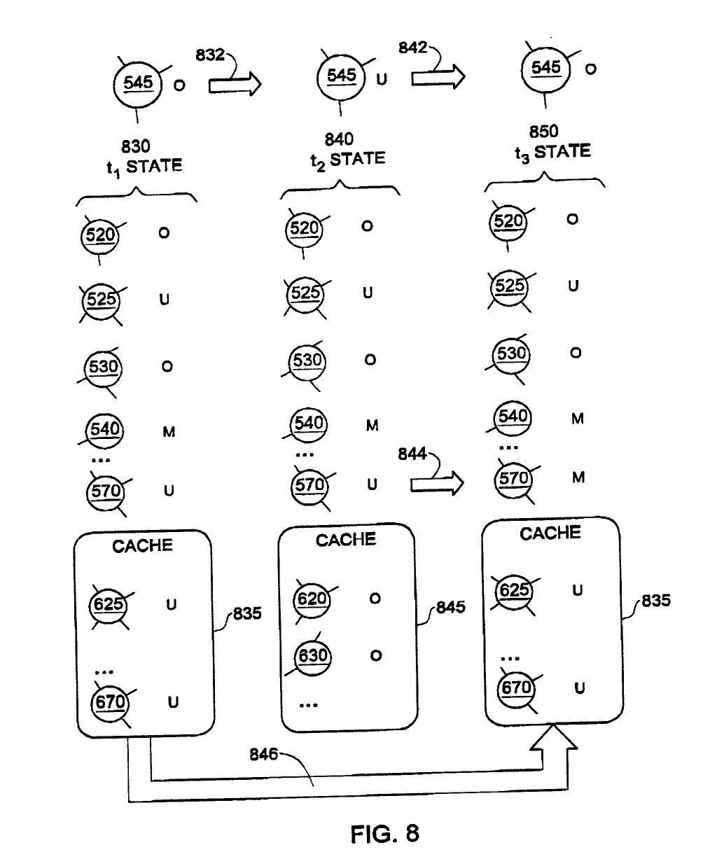

It is first noted that a cluster member may change state and subsequently return to the previous state. It is thus possible for past cache information to still be valid, and this is especially the case where the return to the previous state occurs within a short time. As illustrated in FIG. 8 (with reference to FIG. 6) for tracking changes to the extent of node 545, at a time t₁ the extent is in a t₁ state 830 such that node 520 is overloaded, node 525 is underloaded, node 530 is overloaded, node 540 is at medium load, and node 570 is underloaded. This is reflected in the contents of a cache 835, with data image 625 (corresponding to node 525) as underloaded and data image 670 (corresponding to node 570) as underloaded. These are the only nodes of the extent that currently have a mutual interest with node 545. Subsequently, a transition 832 takes place such that at a later time t₂, node 545 is underloaded. This is reflected in a cache 845, which represents the overloaded nodes of the extent. Note that nodes at medium load are not part of a cache, since they have no mutual interest with any other nodes. Subsequently, another transition 842 takes place such that at an even later time t₃, node 545 is once again overloaded. If the elapsed time between t₁ and t₃ is relatively small, however, cache 835 can be reused in a retrieval operation 846. However, during the interval between times t₁ and t₃, suppose that a load transition 844 has also taken place so that node 570 is now at medium load instead of being underloaded. In such a case, cache 835 does not perfectly represent the state of the extent at time t₃, because data image 670 erroneously includes node 570 as having a mutual interest with node 545. Other such discrepancies are also possible, so at time t₃ the contents of cache 835 are to be considered as hints only. However, for short time intervals, the majority of the nodes represented in reused cache will in general be correctly designated regarding their current states. For short time intervals, the hints of a reused cache are therefore of high quality.

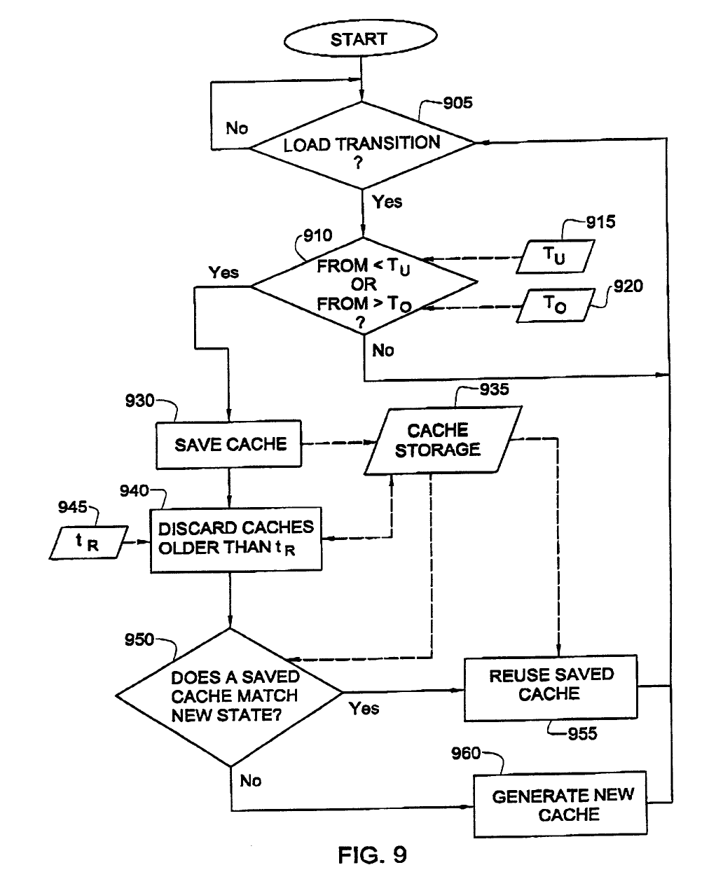

In general, recent past caches are maintained for reuse. As illustrated in FIG. 9, whenever a node undergoes a load transition, this is detected at a decision point 905. If a load transition from one extreme to the other has occurred, the current cache has become invalid. A decision point 910 determines if the load transition is from underloaded or from overloaded, by a comparison with an underload threshold 915 and an overload threshold 920, respectively. If the load transition is from one of these extreme states, in a step 930 the cache is saved in a cache storage 935. In a step 940 caches in cache storage 935 that are older than a reuse time threshold t_{R} 945 are discarded, so that cache storage 935 contains only relatively recent state information. At a decision point 950, it is determined whether the load transition has returned the node to a state represented in one of the caches in cache storage 935. If so, the cache in cache storage 935 representing this previous node state is retrieved for reuse in a step 955. Otherwise, if there is no applicable cache in cache storage 935, then in a step 960, a new cache is generated. The reused cache information is available for hints. Thus, the nodes represented in the reused cache are probed. These nodes recently shared a mutual interest with the node that has just made the load transition, and therefore it is likely they would share this mutual interest again, after the return to the earlier state. By cache reuse, it is possible to find a server for remote execution much faster. If during hint verification, the information represented in the cache is found to be inaccurate, the cache is updated.

### Multi-Site Operation

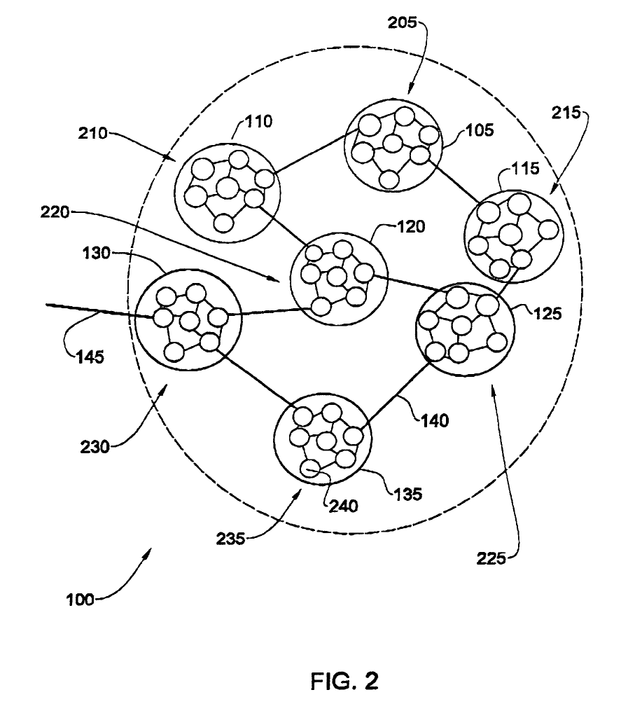

An Internet environment typically has multiple sites which cooperate to achieve a common goal. For example, a multinational corporation might have regional offices located on different continents. Each individual office would be set up to handle local regional business, but in the case of Internet-based services, these various sites are typically able to provide similar services on a global basis. If one site becomes overloaded with Internet requests, it should be possible to alleviate this by rerouting Internet service requests to one of the firm's other sites. According to the present invention, load balancing is extended to such multiple-sites. The term “multiple-site” herein denotes a configuration which can function as a cluster of computing facilities, one or more of which may itself be a cluster. The term “multi-site” as applied to clusters has been previously discussed, as illustrated in FIG. 2, and it is noted that multi-site clusters are higher-level clusters. A high-level cluster can include sub-clusters as well as individual servers as nodes. Within each of the separate sites (clusters) of a multi-site configuration, the distributed load balancing system as previously described is used to balance the load between cluster members of the same site. For multi-site operation, the distributed load balancing system is extended as described below.

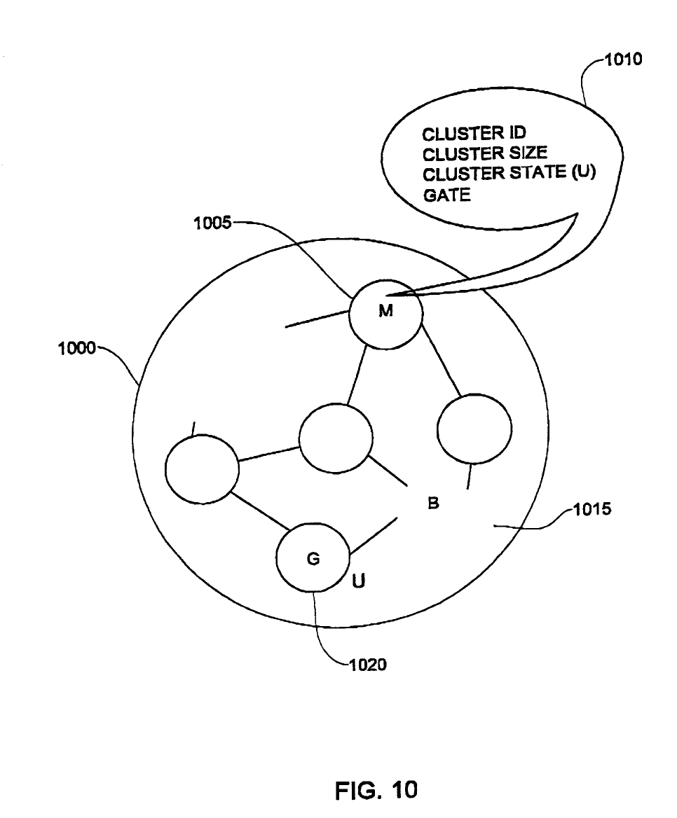

As illustrated in FIG. 10, a cluster 1000 for a multi-site configuration has a monitor 1005, which is a node that is designated to track the activities and status of cluster 1000. (Note that cluster 1000 is a sub-cluster within the higher-level cluster of the multi-site configuration.) Also provided is a “hot backup” 1015 which is able to perform the functions of a monitor in the event that monitor 1005 become unable to function properly for any reason. In addition, a node of cluster 1000 is selected to be a gate 1020. The term “gate” herein denotes a device or computing facility which is explicitly designated to interact with other nodes or sub-clusters that are part of the same multi-site configuration. In this example, gate 1020 is designated to interact with other nodes or sub-clusters which are part of the multi-site configuration including cluster 1000 as a sub-cluster.

Any three distinct cluster members of cluster 1000 can function as monitor 1005, hot backup 1015, and gate 1020, depending on the circumstances. In this manner, the symmetric architecture is preserved Monitor 1005 stores the addresses of all the cluster members of cluster 1000. Furthermore, monitor 1005 is always added to the extent of a node in cluster 1000 and is thus informed of the load on individual servers, in order to support cluster load tracking. Likewise, monitor 1005 is also informed of failed or suspected failed nodes to support health tracking. All cluster members of cluster 1000 are informed of monitor 1005, which is thereby notified of the state of each cluster member. This notification is done a low periodicity. Monitor 1005 can then calculate the overall load estimate of cluster 1000. If cluster 1000 is large, however, a distributed algorithm may be used to calculate the overall load estimate. In a manner analogous to the definition of the previously described node states in a single cluster, cluster states are defined for the sub-clusters of a multi-site configuration. Thus, a sub-cluster which is part of a multi-site configuration can be in an overloaded state O, a medium load state M, or in an overloaded state U, according to an overload threshold T_{O} and an underload threshold T_{U}. Thus, each sub-cluster of a multi-site configuration is characterized by a cluster state. For example, cluster 1000 in FIG. 10 (a sub-cluster in a multi-site configuration) is shown as having an underloaded (U) state.

An overloaded sub-cluster of a multi-site configuration has a gate which is also overloaded, and an underloaded sub-cluster likewise has a gate which is also underloaded. In FIG. 10 node 1020 is in an underloaded state and is therefore eligible to be the gate of cluster 1000.

The respective monitors of the sub-clusters of a multi-site configuration implement the distributed load balancing method of the present invention among themselves, so that overloaded sub-clusters are informed of underloaded sub-clusters, and vice versa. The distributed load balancing method of the present invention therefore operates at the inter-cluster level within a multi-site configuration, and at the intra-cluster level for each Domain Name Server (DNS) name within each of the individual sub-clusters making up the multi-site configuration.

Monitor 1005 informs other nodes, such as via the monitors thereof (for nodes which are other sub-clusters of the multi-site configuration), of characteristics 1010 of cluster 1000, including:

the cluster ID of cluster 1000;

the cluster size (number of cluster members, |S|) of cluster 1000;

the cluster state (overloaded, underloaded, or medium load) of cluster 1000; and

the cluster gate of cluster 1000 (shown in FIG. 10 as gate 1020).

Cluster characteristics 1010 are subject to change regarding the cluster state, gate, and possibly cluster size (which can change in the event of failures, for example). In this manner, the monitors of clusters within a multi-site configuration inform each other of their respective cluster states.

For example, if there is an overloaded cluster ‘X’ with an overloaded node ‘a’ seeking an external underloaded cluster member for load sharing, the monitor of ‘X’ will have been informed of an underloaded cluster ‘Y’ with an underloaded node ‘b’ serving as a gate. Messages are then exchanged directly between ‘X.a’ and ‘Y.b’.

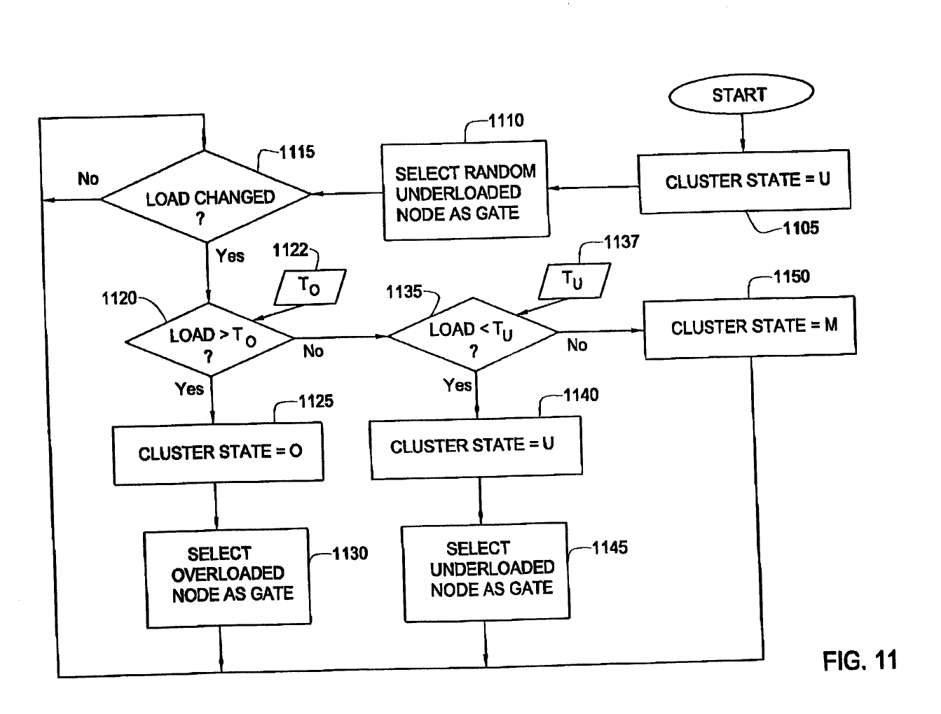

As illustrated in FIG. 11, upon startup, a cluster is initially placed in the underloaded state in a step 1105. In connection with this, all operational cluster members are on alert for distributed load balancing operation. The arrival of any IP message (from the Internet) immediately starts the distributed load balancing code running on all cluster members. In a step 1110, one of the underloaded cluster members is randomly selected to serve as the gate. At a decision point 1115, the load on the cluster is checked. If the load has not changed, decision point 1115 is repeated. If the load has changed, at a decision point 1120 the cluster load is compared against an overload threshold T_{O} 1122, and if the cluster load exceeds T_{O} the cluster state is set to O in a step 1125, and an overloaded node is selected as the gate in a step 1130. If not, however, at a decision point 1135 the cluster load is compared against an underload threshold T_{U} 1137, and if the cluster load is less than T_{U} the cluster state is set to U in a step 1140, and an overloaded node is selected as the gate in a step 1145. If the cluster load neither exceeds T_{O} nor is less than T_{U}, then in a step 1150, the cluster state is set to M. After each such setting, decision point 1115 is repeated.

### Session Support

Once a session is initiated with a specific cluster member (possibly after redirection), that cluster member will normally get all web-requests during the session (from the same client) until the end of the session. The other cluster members which are part of the same extent serve as a backup.

Because of distributed load balancing, however, a cluster member different from that with which the session was initiated may be selected to process a client request during a session. This must be done in such a way as not to interfere with the session with the remote client, nor to give the appearance to the remote client that the request is being handled by different nodes (servers). The system of the present invention handles his by including the initial session node's node address in all replies, regardless of the node (server) that actually handles the client request. For example, if a session is initiated with cluster member ‘b’ by a remote client, it may be necessary to redirect requests from the remote client if cluster member ‘b’ becomes overloaded. If cluster member ‘a’ is currently underloaded and is therefore selected to process a request from the remote client, then cluster member ‘a’ will do the actual processing of the request, but the node address ‘X.b’ is substituted in the reply to the remote client for the node address of cluster member ‘a’, even though the request is actually being handled by ‘X.a’. Any subsequent request by the same client within the same session will be thus directed to the original node (server) ‘X.b’.

### Quality of Service

The present invention supports a basic Quality of Service (QoS) mechanism which gives preference to requests from multiple remote clients according to different levels of priority. Each priority level has a separate priority queue. For example, three priority queues can be assigned. The number of request messages and their sizes are tracked for each of the three priority queues. A feedback mechanism is used to adjust (increase or decrease) the frequency of load balancing (locating mutual interests) for each of the priority queues so that the priority ranking among the priority queues is maintained and the load on all priority queues is accommodated.

It should be noted that there are many different non-limiting applications of the present invention in the general realm of resource allocation and in the specific area of load balancing, including: firewalls, cellular servers (such as WAP and iMode), cellular gateways, cellular infrastructure (such as base stations and switches), network switches, network switch ports, network routers, network interface devices and network interface cards (NIC's), CPU's and other processors (in a multi-processor environment), storage devices (such as disks), and distributed processing applications of all kinds.

In the method claims that follow, alphabetic characters used to designate claim steps are provided for convenience only and do not imply any particular order of performing the steps. It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention. While the invention has been described with respect to a limited number of embodiments, it will be appreciated that many variations, modifications and other applications of the invention may be made.

1. A system for distributed mutual-interest matching in a cluster of a plurality of nodes, wherein at least one node has a mutual interest with at least one other node, the system comprising:
(i) at least one extent, each extent being a subset of the plurality of nodes;
(ii) at least one cache storage, each of said cache storages corresponding to one of said extents; and
(iii) a plurality of caches, at least one of said cache storages containing at least two caches from among said plurality of caches, wherein each cache is operative to containing data images of nodes having a mutual interest with a node, and wherein said data images in at least one cache selectively correspond to past mutual interests.

2. The system of claim 1, furthermore comprising:
(iv) a symmetric architecture.

3. The system of claim 1, wherein the mutual-interest matching effects load balancing.

4. The system of claim 3, wherein said load balancing is for Internet Traffic Management.

5. The system of claim 4, further comprising:
(iv) a symmetric architecture.

6. The system of claim 1, wherein the cluster is connected to a network from a group that includes the Internet, cellular communications networks, and electronic commerce networks.

7. The system of claim 1, wherein each node of the plurality of nodes is a respective individual server.

8. The system of claim 1, wherein at least one node of the plurality of nodes is a sub-cluster.

9. The system of claim 8, wherein said sub-cluster is characterized by a cluster state and comprises:
a) at least one monitor operative to informing nodes of said cluster state; and
b) at least one designated gate operative to interacting with nodes of the cluster.

10. A system for distributed mutual-interest matching in a cluster of a plurality of nodes, wherein at least one node has a mutual interest with at least one other node, and wherein at least one node includes a sub-cluster having a cluster state, the system comprising:
(i) at least one monitor operative to informing nodes of the cluster state, wherein said at least one monitor is included within a sub-cluster; and
(ii) at least one designated gate operative to interacting with nodes of the cluster, wherein said at least one designated gate is included within a sub-cluster.

11. The system of claim 10, wherein the mutual-interest matching effects load balancing.

12. The system of clam 10, wherein the cluster is connected to a network from a group that includes the Internet, cellular communications networks, and electronic commerce networks.

13. The system of claim 10, further comprising:
(iii) a symmetric architecture.

14. The system of claim 11, wherein said load balancing is for Internet Traffic Management.

15. The system of claim 14, further comprising:
(iii) a symmetric architecture.

16. A method for enhancing the locality of distributed mutual-interest matching in a cluster containing a plurality of nodes by measuring and tracking inter-node latencies, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches and wherein each cache is operative to containing data images of secondary nodes having a mutual interest with a primary node, the method comprising the steps of:
(i) detecting a transition of a primary node;
(ii) performing an operation selected from the group including:
a) saving a cache corresponding to a first node state in a cache storage, and
b) retrieving a cache corresponding to a second node state from a cache storage; and
(iii) utilizing the data images contained in a cache for locating a secondary node having a mutual interest with the primary node.

17. The method of claim 16, wherein the distributed mutual-interest matching effects load balancing.

18. The method of claim 17, wherein said load balancing is for Internet Traffic Management.

19. The method of claim 16, wherein a latency exists between at least two nodes, the method further comprising the step of measuring and tracking said latency.

20. The method of claim 16, wherein each node within the plurality of nodes has a node address, wherein said primary node of the plurality of nodes establishes a session with a remote client, and wherein the cluster makes a reply to said remote client, the method furthermore comprising the step of:
(iv) substituting the node address of said primary node for the node address of said secondary node in said reply to said remote client.

21. The method of claim 16, wherein the cluster receives requests from a plurality of remote clients, and wherein said locating a secondary node has an adjustable frequency, the method furthermore comprising the steps of:
(iv) providing a plurality of priority queues, each of said priority queues having a priority level;
(v) tracking the number of requests for a priority queue; and
(vi) adjusting said adjustable frequency.

22. A method for distributed mutual-interest matching in a cluster containing a plurality of nodes, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches, wherein each cache is operative to containing data images of secondary nodes having a mutual interest with a primary node, and wherein each node within the plurality of nodes has a node address, the method comprising the steps of:
(i) detecting a transition of a primary node, wherein said primary node establishes a session with a remote client and wherein the cluster makes a reply to said remote client;
(ii) performing an operation selected from the group including:
a) saving a cache corresponding to a first node state in a cache storage, and
b) retrieving a cache corresponding to a second node state from a cache storage;
(iii) utilizing the data images contained in a cache for locating a secondary node having a mutual interest with the primary node; and
(iv) substituting the node address of said primary node for the node address of said secondary node in said reply to said remote client.

23. A method for distributed mutual-interest matching in a cluster containing a plurality of nodes, wherein at least one node is capable of undergoing a transition from a first node state to a second node state, the cluster further containing at least one extent, wherein each extent is a subset of the plurality of nodes, the cluster further containing at least one cache storage, wherein each cache storage corresponds to one of the extents, the cluster further containing a plurality of caches, wherein at least one cache storage contains at least two caches, wherein each cache is operative to containing data images of secondary nodes having a mutual interest with a primary node, and wherein the cluster receives requests from a plurality of remote clients, the method comprising the steps of:
(i) detecting a transition of a primary node;
(ii) performing an operation selected from the group including:
a) saving a cache corresponding to a first node state in a cache storage, and
b) retrieving a cache corresponding to a second node state from a cache storage; and
(iii) utilizing the data images contained in a cache for locating a secondary node having a mutual interest with the primary node, wherein said locating has an adjustable frequency;
(iv) providing a plurality of priority queues, each of said priority queues having a priority level;
(v) tracking the number of requests for a priority queue; and
(vi) adjusting said adjustable frequency.

24. A method for distributed mutual-interest matching in a cluster of a plurality of nodes, wherein at least one node has a mutual interest with at least one other node, and wherein at least one node includes a sub-cluster having a cluster state, the method comprising:
i) designating a monitor operative to informing nodes of the cluster state, and
ii) designating a gate operative to interacting with nodes of the cluster.

25. A system for distributed mutual-interest matching in a cluster of a plurality of nodes, wherein at least one node includes a sub-cluster, the system comprising at least one seeking node from among the plurality of nodes, such that each one of said at least one seeking node being operative to locating a matching node among the plurality of nodes wherein said matching node has a mutual interest with said seeking node.

26. For use in the system, the of claim 25, a seeking node operative to locating a matching node among the plurality of nodes wherein said matching node has a mutual interest with said seeking node.
